(19) United States
(12) Patent Application Publication
(10) Pub. No.: US 2026/0168285 A1
(43) Pub. Date: Jun. 18, 2026

(54) LOCKING STATUS INDICATOR ASSEMBLY

(71) Applicant: Sargent Manufacturing Company, New Haven, CT (US)

(72) Inventors: Marisol Mael Lara Gomez, Guadalajara (MX); David Martinez Diaz, Tlajomulco De Zuñiga (MX); Andrea Carolina Contreras Ordoñez, Pedregal Del Bosque (MX)

(73) Assignee: Sargent Manufacturing Company, New Haven, CT (US)

(21) Appl. No.: 19/404,684

(22) Filed: Dec. 1, 2025

Related U.S. Application Data
(60) Provisional application No. 63/733,286, filed on Dec. 12, 2024.

(51) Int. Cl. E05B 41/00; E05B 15/02

(52) U.S. Cl. CPC E05B 41/00; E05B 15/02

(57) ABSTRACT

According to some aspects, a status indicator assembly for a lock assembly is disclosed, the status indicator assembly is configured to indicate the locking status of the lock and change with the lock. In some embodiments, indicator assembly includes an indicator configured to fit in an escutcheon attached to the lock assembly. In some embodiments, the indicator is coupled to a coupling arm. In some embodiments, the coupling arm is further coupled to a lock tailpiece in the lock assembly in such a way that as the lock tailpiece rotates due to actuation of the lock, the coupling arm rotates the indicator. In some embodiments, the coupling arm is configured to interlock with the indicator via a slot to reduce unnecessary motion of the indicator.

### CROSS-REFERENCE TO RELATED APPLICATIONS

This application claims the benefit of priority under 35 U.S.C. § 119(e) to U.S. Provisional Application Ser. No. 63/733,286 filed on Dec. 12, 2024, which is hereby incorporated by reference in its entirety.

### FIELD

Disclosed embodiments are related to locking device status indicators and related methods of assembling.

### BACKGROUND

Indicators are used to indicate the status of a lock. A status indicator assembly may be connected to a lock so that when a user locks a lock, an indicator displays a symbol or message indicating to users that the lock is in a locked state. Alternatively, when a user unlocks a lock, the indicator would display a different symbol or message indicating that the lock is in an unlocked state to users.

### SUMMARY

In one embodiment, a status indicator assembly configured to operatively couple to a lock assembly is provided. The lock assembly includes a lock actuator, a lock housing disposed around the lock actuator, and a lock tailpiece extending from the lock actuator along a lock axis and configured to rotate about the lock axis between a tailpiece first position and a tailpiece second position. The status indicator assembly includes an escutcheon configured to engage with the lock housing, the escutcheon comprising a viewing portion. An indicator is disposed within the escutcheon and includes a display portion. The indicator is rotatable about the lock axis relative to the escutcheon between an indicator first position, where the display portion is visible through the viewing portion, and an indicator second position, where the display portion is not visible through the viewing portion. A coupling arm is configured to operatively connect the lock tailpiece to the indicator, such that moving the lock tailpiece to the tailpiece first position moves the indicator to the indicator first position, and moving the lock tailpiece to the tailpiece second position moves the indicator to the indicator second position. The coupling arm and the indicator are connected in such a way to limit movement of the coupling arm relative to the indicator in an axial direction approximately parallel to the lock axis.

In another embodiment, a method for providing an indicator system to a lock assembly is provided. The lock assembly includes a lock actuator, a lock housing disposed around the lock actuator, and a lock tailpiece extending from the lock actuator along a lock axis and configured to rotate about the lock axis between a tailpiece first position and a tailpiece second position of the lock assembly. The method includes engaging an escutcheon with the lock housing, then arranging an indicator in an interior portion of the escutcheon such that a portion of the indicator is visible through a viewing portion of the escutcheon. A coupling arm is engaged with the lock tailpiece via a hub slot in the coupling arm in a first orientation. The coupling arm can then be moved along the lock tailpiece towards the lock housing. The coupling arm pivots in a first direction towards the indicator about the lock tailpiece as the coupling arm approaches the indicator interlocking a distal end of the coupling arm with a portion of the indicator such that the coupling arm and indicator are operatively coupled to rotate from an indicator first position to an indicator second position as the lock tailpiece rotates between the tailpiece first position and tailpiece second position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front, perspective view of an embodiment of a status indicator assembly coupled to a lock assembly;

FIG. 2 is an exploded, perspective view of the status indicator assembly of FIG. 1;

FIG. 3 is a back, perspective view of the status indicator assembly of FIG. 1 coupled to a lock assembly in a first state;

FIG. 4 is a back, perspective view of the status indicator assembly of FIG. 1 coupled to a lock assembly in a second state;

FIG. 5 is a front, perspective view of the status indicator assembly of FIG. 1 assembly coupled to a lock assembly in a second state;

FIG. 6A is a front view of the status indicator assembly of FIG. 1;

FIG. 6B is a side view of the status indicator assembly of FIG. 1;

FIG. 7 is a front, perspective view of a coupling arm of the status indicator assembly of FIG. 1;

FIG. 8A is a side view of a coupling arm of the status indicator assembly of FIG. 1 interacting with the lock assembly and the indicator in a first location;

FIG. 8B is a side view of the coupling arm of the status indicator assembly of FIG. 1 interacting with the lock assembly and the indicator in a second location;

FIG. 8C is a side view of the coupling arm of the status indicator assembly of FIG. 1 interacting with the lock assembly and the indicator in a third location;

FIG. 8D is a side view the coupling arm of the status indicator assembly of FIG. 1 interacting with the lock assembly and the indicator in a fourth location;

FIG. 9A is a sectional side view of the coupling arm of the status indicator assembly of FIG. 1 coupled to the lock tailpiece in a first orientation;

FIG. 9B is a sectional side view of the coupling arm of the status indicator assembly of FIG. 1 coupled to the lock tailpiece in a second orientation;

### DETAILED DESCRIPTION

As mentioned above, status indicators may be useful to indicate the lock status of a lock assembly (e.g. whether the door lock is locked or unlocked). This may allow users to visually assess the lock status of a lock assembly without needing to physically interact with the lock assembly. Conventional status indicators are generally operatively coupled to lock assemblies such that when the lock assembly is set to a particular status, the indicator automatically displays that status without requiring a user to manually adjust the status indicator. Such a configuration ensures that the status indicator always accurately displays the true lock status of the lock assembly.

However, currently known designs of status indicators have poor mechanical connections between the lock assembly and the indicator assembly, potentially causing detachment and/or misalignment of the status indicator relative to the lock assembly. This can potentially lead to problems operating the lock or displaying the proper lock status. For instance, if the indicator assembly becomes misaligned or detached, the indicator may no longer accurately reflect the lock status of the lock assembly. Additionally, such misalignment or detachment may cause binding between components of the indicator assembly and lock assembly, interfering with normal operation of the lock assembly. The inventors have therefore recognized and appreciated a status indicator assembly that can securely fit to a lock assembly may be advantageous.

According to some embodiments, the status indicator assembly may be configured to engage with a conventional lock assembly. Such a conventional lock assembly may include a lock housing which holds a lock actuator (e.g. a lock cylinder, a thumb-turn, an electro-mechanical actuator, etc.). A user may lock or unlock the lock assembly by operating the lock actuator. The lock actuator may be operatively coupled to a lock tailpiece such that operating the lock actuator causes the lock tailpiece to rotate about a lock axis. The lock tailpiece may be operatively coupled to a conventional lock body (e.g. a lock body which includes a latch and/or a deadbolt), such that rotating the lock tailpiece about the lock axis moves the lock body between locked and unlocked positions.

The status indicator assembly may include an escutcheon, an indicator, and a coupling arm. The escutcheon may couple to the lock assembly and the indicator may be positioned inside of the escutcheon and encircle a portion of the lock actuator. Additionally, the escutcheon may have at least one viewing portion so that a portion of the indicator is visible through the escutcheon. In some embodiments, the escutcheon may have multiple viewing portions to increase visibility of information from the indicator through the viewing portions.

The coupling arm may connect with the indicator at one portion of the coupling arm and connect with the lock tailpiece at another portion of the coupling arm, such that as the lock tailpiece moves, the indicator also moves via the coupling arm. In some embodiments, the lock tailpiece may rotate when a user actuates the lock, causing the coupling arm to rotate the indicator within the escutcheon. This may cause the indicator to rotate about the lock axis from a first position, indicating that the lock is locked through the viewing portion of the escutcheon, to a second position, indicating that the lock is unlocked through the viewing portion of the escutcheon or vice-versa.

In conventional status indicator assemblies, which couple the lock tailpiece to a status indicator, the coupling arm slides directly into a channel in an indicator to couple the indicator to a lock tailpiece. The inventors have recognized that such an arrangement does not adequately secure the coupling arm to the indicator such that excess movement may cause the coupling arm to slide out of the indicator and decouple from the indicator. For instance, the coupling arm may be jostled during lock actuation and slide away from the indicator along the lock axis, thus detaching from the status indicator. The inventors have recognized that it may be beneficial for a coupling arm to couple to the lock tailpiece, via a hub slot in the coupling arm and for the coupling arm to interlock with the indicator so that excess motion does not decouple the coupling arm from the indicator. The coupling arm may have distal portion having a distal slot and a projection. The distal slot can receive the indicator radially, securing the indicator between two walls of the distal slot. In addition, the projection can be received by a notch in the indicator, allowing the coupling arm to rotate the indicator. The connection between the coupling arm and the indicator is configured to limit movement of the coupling arm relative to the indicator in an axial direction approximately parallel to the lock axis.

It should be appreciated that the coupling arm may not be able to slide directly onto the indicator due to one of the walls of the distal slot. To effectively couple the coupling arm to the indicator, the distal end of the coupling arm may pivot towards the indicator so that one wall of the distal slot may contact one side of the indicator. The indicator may then pivot in an opposite direction so that the second wall of the distal slot contacts the opposite side of the indicator. The inventors have appreciated that it may be desirable for the hub slot of the coupling arm to be tapered, allowing the coupling arm to effectively pivot while coupled to the lock tailpiece. It should be appreciated that it may be desirable for there to be several hub slots on the coupling arm, allowing the coupling arm to couple to the lock tailpiece in a plurality of orientations.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

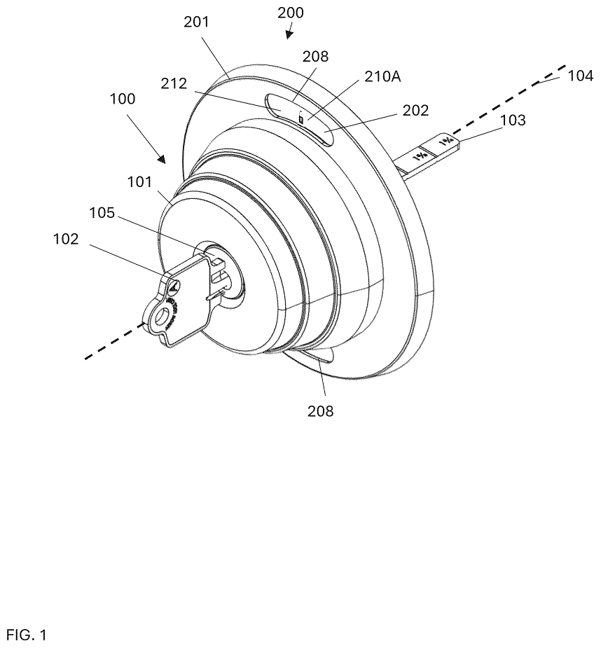

FIG. 1 illustrates a lock assembly 100 coupled to a status indicator assembly 200 in an unlocked orientation according to an embodiment. The lock assembly 100 includes a lock housing 101 with a lock actuator 105. The lock actuator 105 is operatively coupled to a lock tailpiece 103, such that actuating the lock actuator 105 rotates the lock tailpiece 103 about a lock axis. Lock actuator 105 may be any suitable actuator which is capable of rotating lock tailpiece 103, such as a key cylinder, a thumb-turn, an electromechanical actuator, etc. For instance, as seen in FIG. 1, the lock actuator 105 may be a key cylinder operated by key 102. The lock tailpiece 103 is configured to engage with a conventional lock body of a door lock system, such that rotating the tailpiece about the lock axis 104 moves the lock body between locked and unlocked positions. For instance, the lock tailpiece 103 may be operatively coupled to a deadbolt in the lock body (not shown) so that rotating the tailpiece 103 extends or retracts the deadbolt. As discussed above, it may be desirable for users of the lock assembly 100 to be able to quickly ascertain the lock status of lock assembly 100. The inventors have therefore recognized that it may be advantageous for the status indicator assembly 200 to be configured to operatively couple to the lock assembly 100 to display the lock status of the lock assembly 100.

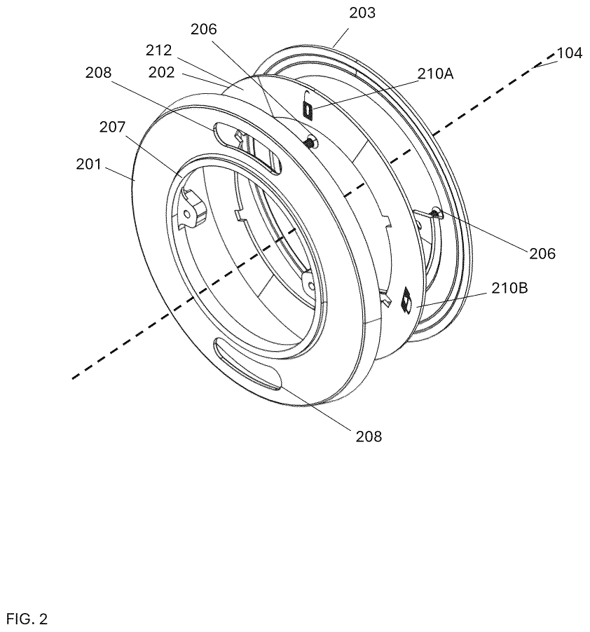

FIG. 2 illustrates an exploded perspective view of some components of the indicator assembly 200. The status indicator assembly 200 includes an escutcheon 201 which is configured to engage with the lock housing 101. In some embodiments the escutcheon 201 includes an alignment projection 207 which is configured to be received into the lock housing 101 in order to ensure proper alignment of the status indicator assembly 200 with the lock assembly 100. The escutcheon 201 includes a at least one viewing portion 208, through which an indicator 202 may be seen. The indicator 202 includes a first display portion 210A and a second display portion 210B on a first face 212, which may be used to indicate the lock status of a lock through the at least one viewing portion 208 of the escutcheon 201. For instance, as seen in FIG. 2, the first display portion 210A includes an unlocked icon, and the second display portion 210B includes a locked icon. The indicator 202 is configured to rotate about the lock axis 104 within the escutcheon 201, changing which of display portions 210A or 210B is visible through the viewing portion 208. It should be appreciated that the number of viewing portions 208 is not limiting. Additional viewing portions may increase visibility of information to users. It should also be appreciated that the display portions 210A and 210B may include any drawings, text, symbols, colors, or other means of communicating the status of the door lock, as the disclosure is not so limited.

The inventors have appreciated that it may be desirable to reduce movement and excess motion in the indicator 202. Excess motion includes motion that does not cause the indicator to move from a locked indicating state to an unlocked indicating state, such as translation along the lock axis 104. In some embodiments, the indicator assembly 200 therefore includes a securing ring 203 that connects to the escutcheon 201 (e.g. via a plurality of fasteners 206). The securing ring 203 may limit motion of the indicator 202 along the lock axis 104 by maintaining the position of the indicator 202 between the escutcheon 201 and the securing ring 203. The indicator 202 is positioned inside of the escutcheon 201 and between the escutcheon 201 and the securing ring 203 so that the indicator 202 may move relative to the escutcheon 201 in a plane substantially parallel to the securing ring 203.

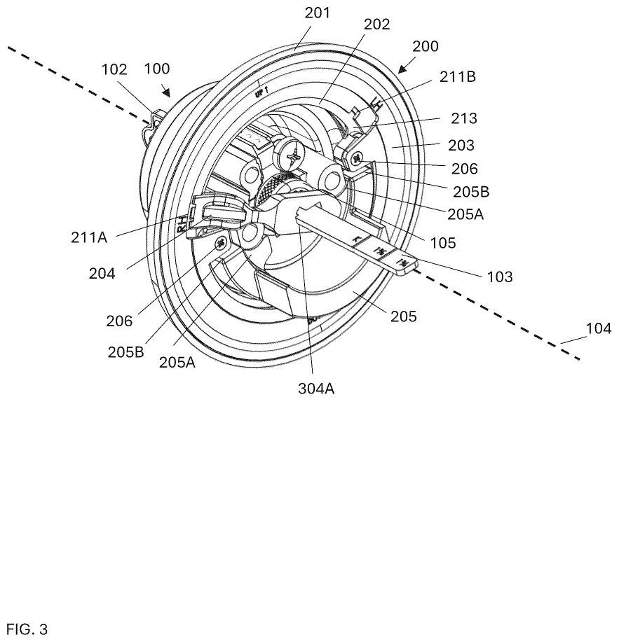

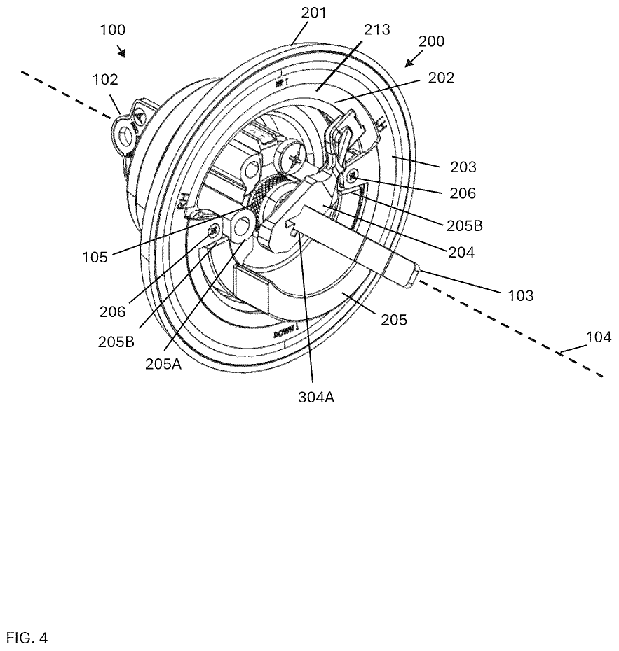

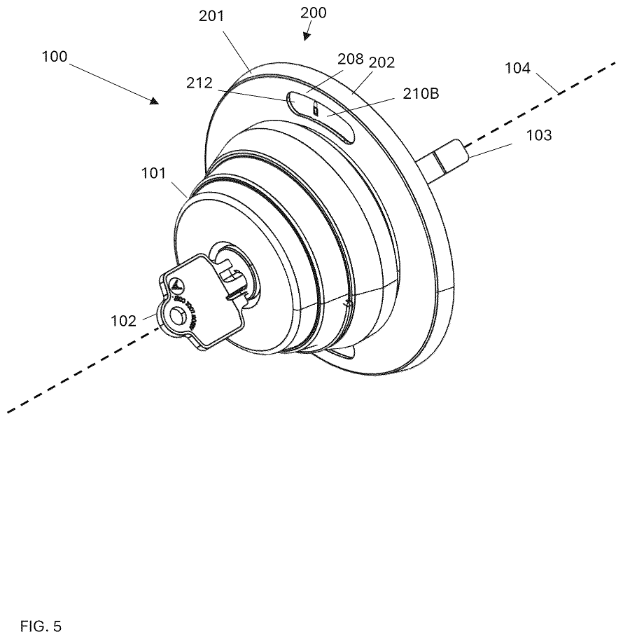

FIGS. 3 and 4 illustrate rear views of the lock assembly 100 with the status indicator assembly 200 of FIG. 1 in a first unlocked position and a second locked position, respectively, further depicting how the status indicator assembly 200 interacts with the lock assembly 100. As discussed above, the indicator 202 may be coupled to the lock tailpiece 103, such that as the lock tailpiece 103 rotates, the indicator 202 may also rotate. In order to lock or unlock the door lock system, a user may operate lock actuator 105 (e.g. by rotating key 102) which in turn rotates the lock tailpiece 103 to actuate a locking component (e.g. deadbolt, latch, etc.) of the lock body (not shown), changing the door lock system from an unlocked position (FIG. 3) to a locked position (FIG. 4). FIG. 5 illustrates a front perspective view of the lock assembly 100 in the locked position with the indicator 202 showing the second display portion 210B, indicating the assembly 100 is locked.

The status indicator assembly 200 includes a coupling arm 204 which operatively couples the lock tailpiece 103 and the indicator 202. In this manner, as the tailpiece 103 is rotated between positions shown in FIGS. 3 and 4, the indicator 202 is also rotated between positions via the coupling arm 204. The inventors have recognized that excessive motion or forces applied to the lock assembly 100 and/or the status indicator assembly 200 during operation of the lock actuator may jostle the coupling arm 204, which may disconnect the coupling arm 204 from the indicator 202, preventing the status indicator assembly 200 from working properly. The inventors have therefore recognized that it may be desirable to securely connect the coupling arm 204 to both the indicator 202 and the lock tailpiece 103 in order to limit the risk of disconnection of the coupling arm 204 from the indicator 202 or the lock tailpiece 103. More details about the secure connection between the coupling arm 204 and the indicator 202/lock tailpiece 103 will be discussed further below.

In some embodiments, the indicator assembly includes a position component 205 in the status indicator assembly 200. The position component 205 may be arranged inside of the lock housing 101 about the lock axis 104 and is positioned to limit excess translatory motion of the indicator 202 in a plane approximately perpendicular to the lock axis 104. The position component 205 may keep the indicator 202 at a constant position relative to the lock axis 104. The position component 205 contacts a stationary portion of the lock assembly 100 at a hook portion 205A of the position component 205. The hook portion 205A prevents the position component 205 from rotating relative to the lock assembly 100.

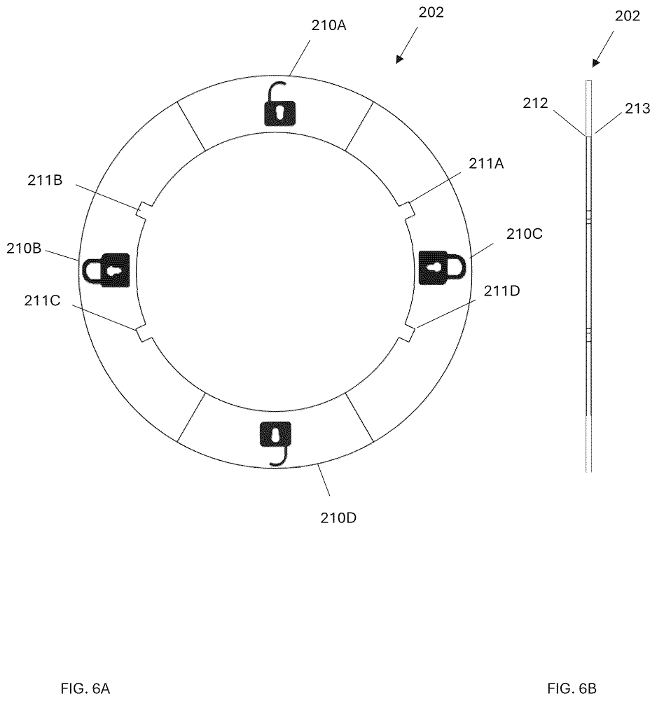

In addition, the position component 205 may further contact portions of the securing ring 203 at a flat portion 205B. It should be appreciated that each portion does not necessarily need to be hook portion or flat portion. Each portion may be any appropriate shape that suitably limits rotation of the escutcheon 201 and securing ring 203 relative to the lock assembly 100. It should be appreciated that the flat portions 205B are positioned to prevent the securing ring 203 from rotating as the indicator 202 rotates due to lock actuation. It should further be appreciated that because the securing ring 203 is connected to the escutcheon 201, the flat portions 205B also prevent the escutcheon 201 from rotating due to lock actuation. In some embodiments the position component 205 may have an edge that acts as a barrier to limit the translatory motion of the indicator. The position element may also be semi-annular shaped, allowing the indicator to rotate about it, while also allowing the position element to easily fit inside lock assemblies. FIGS. 6A and 6B depict front and side views of indicator 202. The indicator 202 may be substantially ring shaped, allowing the indicator 202 to easily fit inside of an escutcheon and rotate. However, it is contemplated that the indicator 202 may be any suitable shape which allows for rotation within the escutcheon (e.g. a crescent), as the disclosure is not so limited. As previously discussed, the indicator 202 has a first display portion 210A having a symbol of an unlocked lock, and a second display portion 210B having a symbol of a locked lock. However, in some embodiments, the indicator 202 may have additional display portion 210C having a symbol corresponding to the symbol of 210B, and additional display portion 210D having a symbol corresponding to the symbol of 210A. Such additional display portions may allow for the proper lock status symbol to be displayed through multiple different viewing portions 208.

The display portions' 210A, 210B, 210C, and 210D shape, position, and quantity should not be considered limiting. It may be desirable to have the display portions be different symbols indicating the status of a lock, it may also be desirable to have a different number of display portions spaced in different orientations depending on the lock and escutcheon used. It should be appreciated in the embodiment that the display portions are radially positioned so that the rotation required to rotate the indicator 202 to have a different display portion viewable through the escutcheon 201 viewing portion 208 is dependent on the rotation of the lock tailpiece 103 as a result of actuating the lock between a locked and unlocked state.

The indicator 202 may also have at least one notch 211 capable of receiving a coupling arm 204 and allowing the coupling arm 204 to connect the indicator 202 to the lock tailpiece 103. However, as will be discussed further below, it may be desirable to include multiple notches 211 in order to allow for the status indicator assembly to be configured in either a right-handed or a left-handed configuration. For example, notch 211A may be configured to connect to the coupling arm 204 when the indicator assembly 200 is in a right-handed position, and notch 211B may be configured to connect to the coupling arm 204 when the indicator assembly 200 is in a left-handed position. Additional notches 211C and 211D may correspond to notch 211A and 211B, respectively, so that the indicator 202 may be inserted into the escutcheon 201 in any configuration. For instance, if the indicator 202 were to be rotated 180 degrees about the lock axis, such that display portion 210D were at the top, notch 211C may be configured to connect to the coupling arm in the right-handed position instead of notch 211A and notch 211D may be configured to connect to the coupling arm in the left-handed position instead of notch 211B. The indicator 202 may be arranged in an interior portion of the escutcheon 201, such that the escutcheon 201 at least partially encloses the indicator 202 between the escutcheon 201 and the door.

FIG. 6B illustrates the indicator 202 having two faces, a first face 212 having the display portions 210A and 210B and a second face 213 opposite the first face. It should be appreciated that the display portion may be a variety of different signs or signals commonly understood to indicate the state of the lock. For example, in one embodiment a display portion may be a drawing of a locked lock, indicating a locked state. In another embodiment the display portion may be a drawing of an unlocked lock indicating an unlocked state. In another embodiment the display portion may be a line of text reading “LOCKED” indicating the lock is locked. In yet another embodiment, the display portion may be a line of text reading “UNLOCKED” indicating the lock is unlocked. It should be appreciated that color may also be used on the display portion to indicate the status of the lock. For example, in some embodiments red on the display portion may indicate the lock is locked, while in other embodiments green on the display portion may indicate the lock is locked. The inventors have appreciated that any suitable texts, symbols, and/or colors, in any suitable combination may be used to indicate the status of the door as the disclosure is not so limited. It should be appreciated that the combination of alternating display portions and notches allows for the display to alternate between locked and unlocked orientations when the indicator is in either a right-hand position or a left-hand position and it should be appreciated that the indicator can be switched between a right-hand orientation and the left-hand orientation.

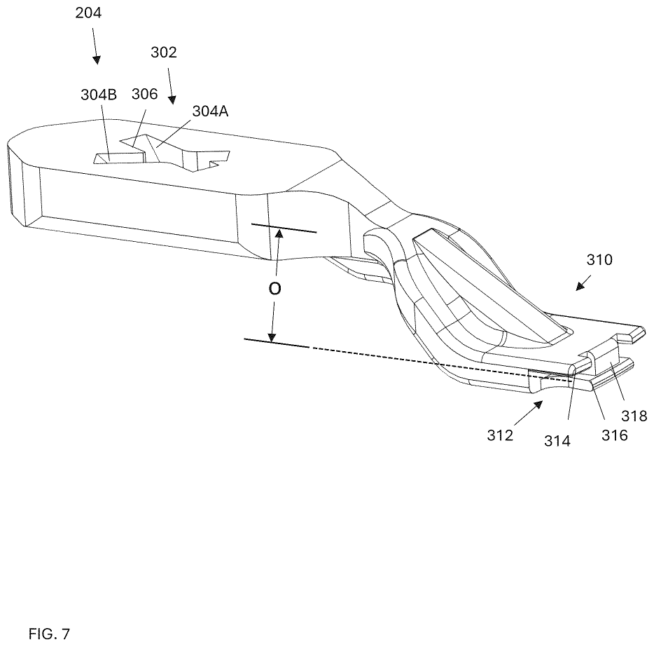

FIG. 7 illustrates the coupling arm 204 having a hub portion 302 and a distal portion 310 according to an embodiment. In some embodiments, the hub portion 302 includes a plurality of hub slots 304 configured to receive the lock tailpiece 103 and allow the coupling arm 204 to slide along the length of the lock tailpiece 103 towards the lock assembly 100 and indicator 202. In some embodiments, the hub slots 304 may have tapered portion(s) 306, further allowing to the coupling arm 204 to pivot about the lock tailpiece 103. More details regarding the tapered portion(s) 306 will be discussed further below.

As discussed above, the inventors have recognized that it may be desirable for the indicator assembly 200 to be capable of accurately displaying the lock status of door lock systems in multiple different configurations. For example, many lock assemblies may be configured to be either left-handed or right-handed. However, switching a lock assembly between a right-handed configuration and a left-handed configuration often requires reversing the direction of rotation of the lock tailpiece 103. The inventors have therefore recognized that it may be desirable to include multiple hub slots 304 arranged at different angles in order to allow the coupling arm 204 to attach to the indicator 202 in either a right-handed configuration or a left-handed configuration. For instance, as best seen in FIG. 3 the hub slot 304A may be inserted over lock tailpiece 103 in order to allow the coupling arm 204 to connect to the indicator 202 at a notch 211A corresponding to the right-handed position. If a left-handed configuration was desired, the hub slot 304B may be received over the lock tailpiece 103 instead of the hub slot 304B in order to allow the coupling arm 204 to connect to the indicator 202 at notch 211B corresponding to the left-handed position.

In some embodiments, the hub slots 304 may be overlapping, such that the hub slots 304 may form a substantially “X” shape as best shown in FIG. 7. However, it should be appreciated that any layout of hub slots 304 which allow for the coupling arm 204 to be attached to the indicator 202 in either the left-handed configuration or the right-handed configuration is contemplated, as the disclosure is not so limited.

As discussed above, the inventors have recognized that it may be desirable for the coupling arm 204 to securely connect to the indicator 202 in order to minimize the risk of disconnection of the coupling arm 204 during repeated use. Specifically, the inventors have recognized that it may be desirable to limit translation of the coupling arm along the lock axis 104 in order to avoid such disconnection. In some embodiments, the distal portion 310 of the coupling arm 204 may include a distal slot 312 shaped to interlock with the indicator 202. The distal slot 312 may have a first wall 314 and second wall 316. In some embodiments, the first wall 314 may be adjacent to the first face 212 and the second wall 316 may be adjacent to the second face 213. It should be appreciated that the first wall 314 and the second wall 316 may be the same height. Alternatively, the first wall 314 and the second wall 316 may be different heights. For example, the first wall 314 may be slightly taller than the second wall 316, so that the walls may more easily interlock with the indicator 202. It should be appreciated that the extra height of the first wall 314 may increase the surface area of contact of the first wall 314 with the indicator 202, thus may reduce the risk of coupling arm 204 disengaging from the indicator 202 due to excess vertical or pivotal movement. In addition, the first wall 314 and the second wall 316 may be substantially the same shape. Alternatively, the first wall 314 and the second wall 316 may be substantially different shapes. For example, the first wall 314 may be straight, while the second wall 316 may be rounded. It should be appreciated that the first wall 314 may be shaped such that the indicator notch 211 is at least partially visible behind the first wall 314 while interlocking with the distal slot 312, making it easier for a user to locate and engage the distal slot 312 with the notch 211. The first wall 314 may be oriented to face the first face 212 of the indicator 202, and the second wall 316 oriented to face the second face 213 of the indicator 202. When indicator 202 is received in the distal slot 312, translation of the coupling arm 204 along the lock axis is limited, as contact between the indicator 202 and the first wall 314 and/or second wall 316 may prevent any such translation. The distal slot 312 may also include a projection 318. The projection 318 is configured to fit inside one of the notches 211 of the indicator 202 in order to transfer rotational forces from the coupling arm 204 to the indicator 202. Mor specifically, sides of the projection 318 are configured to contact sides of one of the notches 211, which push the indicator about the lock axis 104 when the coupling arm rotates about the lock axis 104. In some embodiments, the distal portion 310 may be offset a distance O from the hub portion 302. Such a configuration may allow for sufficient clearance between the hub portion 302 and the lock actuator 105 while allowing the distal portion to engage with the indicator 202.

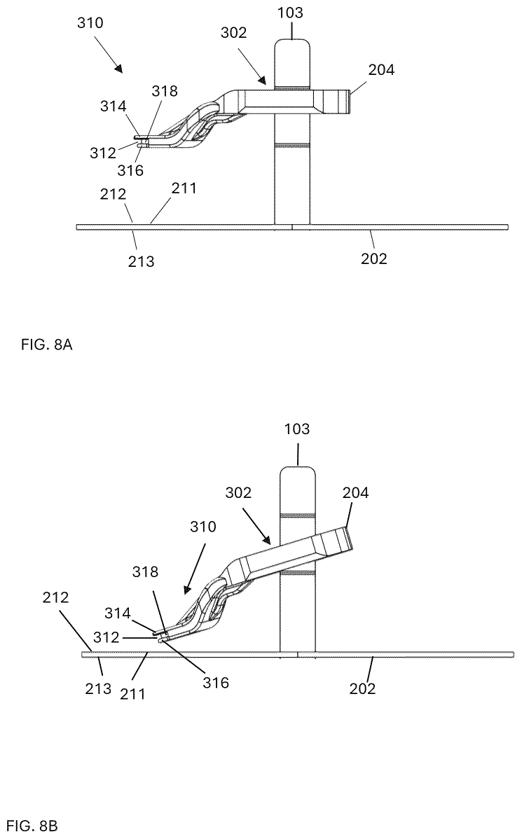

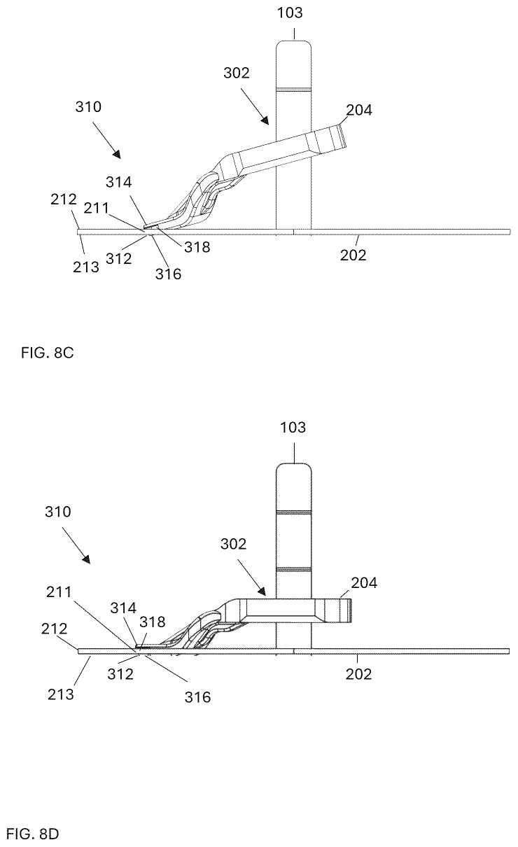

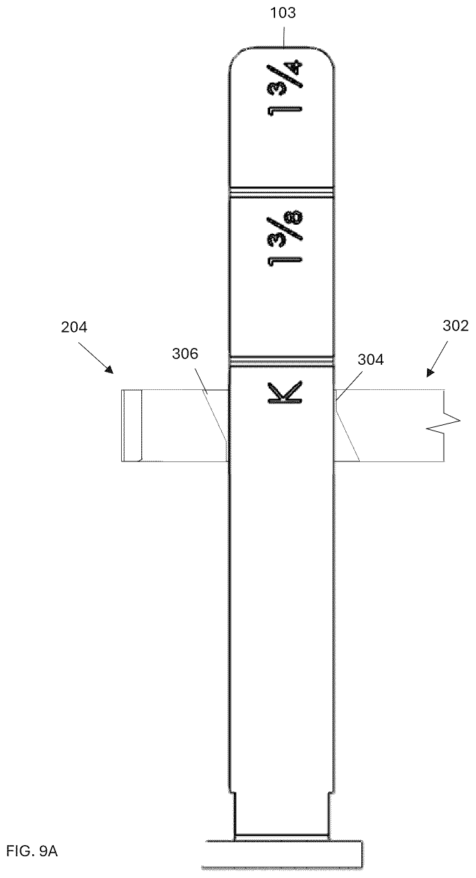

FIGS. 8A-8D illustrate the process of connecting the coupling arm 204 to the indicator 202 and creating a link between the indicator 202 and the lock tailpiece 103. The coupling arm 204 may connect to the indicator 202 in a direction radial to the lock tailpiece 103. As discussed above, the inventors have appreciated that it may be challenging to connect the coupling arm 204 to the indicator 202 in a direction radial to the lock tailpiece 103 by only moving the coupling arm 204 along the lock tailpiece 103 due to the distal portion 310 of the coupling arm 204 interfering with the indicator 202 before forming a connection. Specifically, if the coupling arm 204 were simply translated along the lock axis 104 when being slid onto the tailpiece 103, the second wall 316 of distal slot 312 would contact the indicator 202 and prevent the indicator 202 from being received in the distal slot 312 and prevent the projection 318 from being received into one of notches 211. The inventors have therefore recognized that it may be desirable to construct the coupling arm 204 so that it is capable of rotating towards the indicator 202 as the coupling arm is being slid over the lock tailpiece 103.

FIG. 8A illustrates the coupling arm 204 coupled to the lock tailpiece 103 via one of the hub slots 304. The coupling arm 204 may move along the length of the lock tailpiece 103 or pivot relative to the tailpiece.

FIG. 8B depicts the coupling arm 204 moving along the lock tailpiece 103 approaching the indicator 202, while also pivoting about the lock tailpiece 103 at the hub portion 302, moving the distal portion 310 towards the indicator 202. It should be appreciated that the movement along the lock tailpiece 103 and the pivoting about the lock tailpiece 103 are not movements dependent on one another. The coupling arm 204 may move along the lock tailpiece 103 and pivot about the lock tailpiece 103 simultaneously or in an alternating manner.

FIG. 8C illustrates the coupling arm 204 contacting with the indicator 202. The first wall 314 of the distal slot 312 initiates contact with the first face 212 indicator 202 at one of the indicator's notches 211 as the coupling arm 204 continues to move along and pivot about the lock tailpiece 103. The first wall 314 may contact the first face 212, so that the distal portion 310 is positioned at an acute angle relative to the indicator 202.

Upon the first wall 314 of the distal slot 312 contacting the first face 212 of the indicator 202, the coupling arm 204 may now pivot about the distal portion 310 of the coupling arm 204 as shown in FIG. 8D, decreasing the angle between the distal portion 310 and the indicator 202. Upon pivoting about the distal portion 310 of the coupling arm 204, the hub portion 302 may continue to move along the lock tailpiece 103 towards the indicator 202. As the coupling arm 204 pivots the projection 318 is then received by the notch 211 in the indicator 202. The connection between the projection 318 and the notch causes the indicator 202 and the coupling arm 204 to rotate together. The second wall 316 of the distal slot 312 contacts the second face 213 of the indicator interlocking the coupling arm 204 with the indicator 202. It should be appreciated that interlocking the indicator 202 and the coupling arm 204 may reduce undesired movement of the indicator 202, such as rotation or wobbling along an axis approximately perpendicular to the lock axis. The indicator 202 now coupled to the coupling arm 204 may rotate about the lock axis as the coupling arm 204 and lock tailpiece 103 rotates due to actuation of a lock.

In some further embodiments it may be desirable to allow the coupling arm to be pivoted about the lock tailpiece at the point of connection of the lock tailpiece and coupling arm in a direction towards the indicator at an angle that allows the coupling arm to move along the lock tailpiece without contacting the indicator. Once the coupling arm is in a desired position, the coupling arm may be pivoted in the opposite direction as the first pivot to then interlock with the indicator.

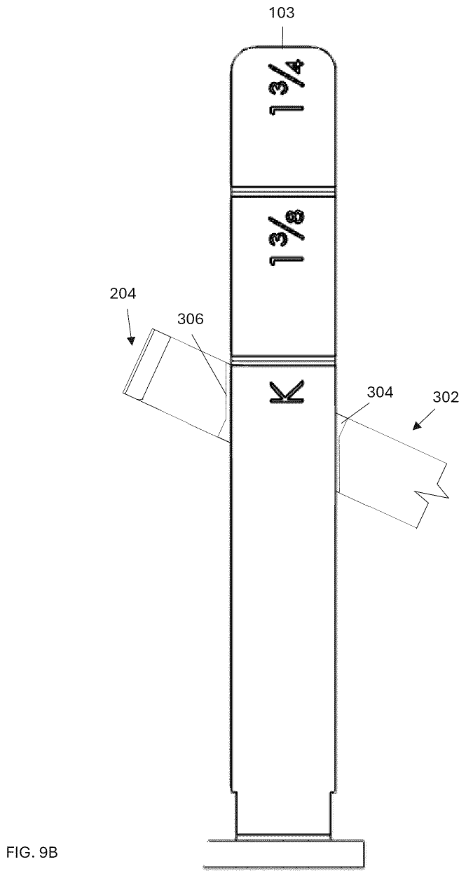

FIGS. 9A and 9B illustrate a section view of the coupling arm 204 pivoting and moving along the lock tailpiece 103 previously described. In order to allow pivoting of the coupling arm 204 as the coupling arm 204 is slid over the lock tailpiece 103, it is necessary for the hub slots 304 to have a sufficient clearance to accommodate the lock tailpiece 103 while the coupling arm 204 pivots. While this may be accomplished by oversizing the hub slots 304, the inventors have recognized that doing so may introduce slop between the coupling arm 204 and the lock tailpiece 103, leading to disconnection of the coupling arm 204 during operation. The inventors have therefore recognized an advantage to including a tapered portion 306 in the hub slots 304 in order to provide this sufficient clearance while also limiting the likelihood of disconnection of the coupling arm 204 due to slop. For instance, as seen in FIG. 9A, when the coupling arm 204 is not pivoted towards the indicator 202 (as will be the case when the coupling arm 204 is fully connected to the indicator 202, there is relatively little clearance between edges of the hub slot 304 and the lock tailpiece 103 in order to reduce slop. However, because of the tapered portion 306, the hub slot 304 may still have sufficient clearance to accommodate pivoting of the coupling arm 204 during attachment of the coupling arm 204 to the indicator 202, as best seen in FIG. 9B.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A status indicator assembly configured to operatively couple to a lock assembly, the lock assembly comprising a lock actuator, a lock housing disposed around the lock actuator, and a lock tailpiece extending from the lock actuator along a lock axis and configured to rotate about the lock axis between a tailpiece first position and a tailpiece second position, the status indicator assembly comprising:
an escutcheon configured to engage with the lock housing, the escutcheon comprising a viewing portion;
an indicator disposed within the escutcheon and comprising a display portion, the indicator being rotatable about the lock axis relative to the escutcheon between an indicator first position, where the display portion is visible through the viewing portion, and an indicator second position, where the display portion is not visible through the viewing portion; and
a coupling arm configured to operatively connect the lock tailpiece to the indicator, such that moving the lock tailpiece to the tailpiece first position moves the indicator to the indicator first position, and moving the lock tailpiece to the tailpiece second position moves the indicator to the indicator second position;
wherein a connection between the coupling arm and the indicator is configured to limit movement of the coupling arm relative to the indicator in an axial direction approximately parallel to the lock axis.

2. The status indicator assembly of claim 1, wherein the coupling arm comprises a hub portion configured to engage with the lock tailpiece and a distal portion configured to engage with the indicator, wherein the distal portion comprises a distal slot configured to receive the indicator and limit axial movement of the coupling arm relative to the indicator.

3. The status indicator assembly of claim 2, wherein the indicator comprises a first face and a second face opposite the first face, the first and second faces being disposed planes approximately perpendicular to the lock axis when the status indicator assembly is coupled to the lock assembly, wherein the distal slot comprises a first wall disposed adjacent to the first face and a second wall disposed adjacent to the second face when the indicator is received in the distal slot.

4. The status indicator assembly of claim 3, wherein the distal portion further comprises a projection configured to engage with a notch in the indicator to transfer rotational forces about the lock axis from the coupling arm to the indicator.

5. The status indicator assembly of claim 2, wherein the hub portion comprises a hub slot configured to receive the lock tailpiece in a first orientation, wherein the indicator is configured to rotate in a first direction from the indicator first position to the indicator second position when the hub slot receives the lock tailpiece in the first orientation.

6. The status indicator assembly of claim 5, wherein the hub slot comprises a tapered portion configured to allow for rotation of the coupling arm about an axis approximately perpendicular to the lock axis when the lock tailpiece is received in the hub slot.

7. The status indicator assembly of claim 5, wherein the hub slot is a first hub slot, and further comprising a second hub slot configured to receive the lock tailpiece in a second orientation, wherein the indicator is configured to rotate in a second direction from the indicator first position to the indicator second position when the second hub slot receives the lock tailpiece in the second orientation, wherein the first orientation configures the indicator to rotate from the indicator first position to the indicator second position in the first direction, wherein the second orientation configures the indicator to rotate from the indicator first position to the indicator second position in the second direction.

8. The status indicator assembly of claim 7, wherein the first hub slot and the second hub slot overlap.

9. The status indicator assembly of claim 8, wherein the first hub slot and the second hub slot overlap in an approximate X shape.

10. The status indicator assembly of claim 7, wherein the first hub slot comprises a first tapered portion configured to allow for rotation of the coupling arm about an axis approximately perpendicular to the lock axis when the lock tailpiece is received in the hub slot and the second hub slot comprises a second tapered portion configured to allow for rotation of the coupling arm about an axis approximately perpendicular to the lock axis when the lock tailpiece is received in the hub slot.

11. The status indicator assembly of claim 1, further comprising a position component disposed within the lock housing configured to receive the indicator.

12. The status indicator assembly of claim 11 wherein the position component is configured to limit the movement of the indicator relative to the lock assembly in a direction approximately parallel to the lock axis.

13. The status indicator assembly of claim 1, wherein the indicator further comprises a second display portion, wherein the second display portion is visible through the viewing portion when the indicator is rotated to the indicator second position.

14. A method for providing an indicator system to a lock assembly, the lock assembly comprising a lock actuator, a lock housing disposed around the lock actuator, and a lock tailpiece extending from the lock actuator along a lock axis and configured to rotate about the lock axis between a tailpiece first position and a tailpiece second position of the lock assembly, the method comprising,
engaging an escutcheon with the lock housing;
arranging an indicator in an interior portion of the escutcheon such that a portion of the indicator is visible through a viewing portion of the escutcheon;
engaging a coupling arm with the lock tailpiece via a hub slot in the coupling arm in a first orientation;
moving the coupling arm along the lock tailpiece towards the lock housing;
pivoting the coupling arm in a first direction towards the indicator about the lock tailpiece as the coupling arm approaches the indicator; and
interlocking a distal end of the coupling arm with a portion of the indicator such that the coupling arm and indicator are operatively coupled to rotate from an indicator first position to an indicator second position as the lock tailpiece rotates between the tailpiece first position and tailpiece second position.

15. The method of claim 14, further comprising pivoting the coupling arm in a second direction opposite the first direction after interlocking the distal end of the coupling arm to the portion of the indicator.

16. The method of claim 14, further comprising interlocking the distal end of the coupling arm to the portion of the indicator after pivoting the coupling arm in a second direction opposite the first direction after.

17. The method of claim 14, further comprising arranging a position component to an interior portion of the escutcheon, fitting the indicator around the position component and securing the escutcheon.

18. The method of claim 14, further comprising attaching a securing ring to the escutcheon so that the indicator is positioned between the escutcheon and securing ring.
